(19) United States
(12) Patent Application Publication
(10) Pub. No.: US 2012/0049474 A1
(43) Pub. Date: Mar. 1, 2012

(54) COLLAPSIBLE HAND CART USED FOR CARRYING ARTICLES

(76) Inventor: Joey Del Rosario, Poway, CA (US)

(21) Appl. No.: 13/103,002

(22) Filed: May 6, 2011

Related U.S. Application Data
(60) Provisional application No. 61/402,409, filed on Aug. 30, 2010.

(51) Int. Cl. B62B 3/02; B62B 11/00; F16B 45/00; B62B 3/00

(52) U.S. Cl. 280/47.34; 280/763.1; 280/651; 248/304

(57) ABSTRACT

A collapsible hand cart is provided for transporting shopping bags, boxes, and other items. The hand cart comprises a support panel having a plurality of hooks nested within a common plane therewith. The hooks can be individual nested hooks, or nested rows of hooks. One or more accessories such as baskets, shelves, straps, and other accessories may be provided, each of the accessories adapted to attach to said nested hooks.

### CROSS REFERENCE TO RELATED APPLICATIONS

This application claims benefit of priority to U.S. Provisional Ser. No. 61/402,409, filed Aug. 30, 2010, the entire contents of which are hereby incorporated by reference.

### FIELD OF THE INVENTION

This invention relates generally to hand carts, and more particularly to a collapsible hand cart for the movement and handling of a plurality of articles such as groceries and other packaged products.

### BACKGROUND OF THE INVENTION

The use of carts and hand trucks for transporting articles such as boxes and bags is widely known in the art. Often retailers will provide carts or dollies to be used by their patrons for use while shopping. One problem with these provided carts is that they are typically restricted to use only at the particular retail establishment. Accordingly, these carts are not useful for shopping at a plurality of adjacent locations, or at for example a farmers market.

Another problem includes the difficulties presented when unloading and transportation purchased goods from a shopper's automobile to an apartment, or house. Typically, a shopper carries one or more boxes and bags into the apartment complex, making a number of trips between the home and the car before completing the transfer of the purchased goods. This requires extensive work and effort, and can become a safety hazard for certain elderly, disabled, and other shoppers. It would be of benefit to provide a cart that is useful both at a shopping location and at home, and in addition being adapted for collapsing into a small form factor for transporting between locations.

There has yet to be made available a suitable hand cart for these and other problems.

For example, U.S. Pat. No. 5,678,842, titled “COLLAPSIBLE CART”, describes a collapsible cart for transporting a plurality of handled shopping bags. For the transportation of small, light weight articles, this cart might be suitable. However, one problem with this collapsible cart includes the absence of a shelf for carrying bulky or heavy items, such as a gallon of milk or case of soda. Many shoppers buy products contained in large boxes, such as at restaurant supply, or wholesale stores. Accordingly, the collapsible cart described in the '842 patent is limited by the products a consumer might be able to purchase and transport. Specifically, the '842 collapsible cart is not adapted to carry boxes or large rectangular packages.

Another example of the prior art includes U.S. Pat. No. 6,880,851, titled “HAND CART”, which describes a hand cart for transporting articles by a user. One problem associated with this hand cart is its bulk size. More specifically, portability with the '851 cart is an issue because the cart does not fold to a small form-factor for ease in portability. Additionally, the cart may become unbalanced and topple when loaded with articles, potentially damaging the articles therein. Yet another limitation includes a design weakness with respect to the upper shelf of the '851 cart. The linkage structure of the '851 cart limits the weight of the load that the shelf can hold; whereas overloading of the shelf may cause a malfunction. The plurality of hook members used for receiving at least one bag of groceries also presents other problems with the '851 cart. First, the durability and strength of hook members affixed to the backing member are subject to a weak coupling connection and may bend or fatigue over time. Secondly, the cart is unable to withstand heavy bags, or those holding substantial weight, due to the inherent design of the hook members and backing connection. Furthermore, the extended hooks present a potential danger and obstacle as they extend outwardly in a dangerous manner such as to raise a potential for injury.

It would therefore be an improvement in the crowded art of hand carts to provide a light weight cart which is durable and designed to withstand heavy loads. It would be of particular benefit for the cart to have a means of stabilizing itself as to not topple when left unattended. Additionally, the cart would benefit from non-obstructive hooks for retaining a number of bags and other articles. Other valuable features of an improved collapsible hand cart will become apparent to one having skill in the art upon further review of the embodiments described herein.

### SUMMARY OF THE INVENTION

It is therefore an object of the invention to provide a durable, collapsible cart with nested hooks for the use of transporting articles both within a shopping environment and at home. The invention includes planar nested tabs that serve as hooks for attaching accessories, such as shelves and baskets, and alternatively for hanging shopping bags directly thereon. It is another objective of the present invention to provide a cart adapted with a stabilization system for maintaining stability in an upward standing position. In addition the present invention is adapted to collapse and reduce its size for added portability. The ability to be compact and low profile allows for ease of transportation and storage of the cart when not in use.

In a general embodiment of the invention, a hand cart is provided for transporting objects, the hand cart comprises a frame, a support panel, and at least two wheels. The support panel further comprises a plurality of hooks, wherein each of the plurality of hooks is nested within a plane of the support panel.

One or more accessories can be provided such as baskets, shelves, straps, and other accessories. Each of these accessories is adapted to attach to the hand cart at the nested hooks.

In another embodiment, the invention includes a rear support attachment for attaching to a standard dolly or hand cart. The attachment comprises a plurality of hooks disposed within a plane of the rear support panel.

### BRIEF DESCRIPTION OF THE DRAWINGS

These and other attributes of the invention are further described in the following detailed description, particularly when reviewed in conjunction with the drawings, wherein:

FIG. 1 illustrates perspective view of a portable collapsible hand cart according to various embodiments of the invention, the hand cart includes a rear support panel having a plurality of hooks nested therein.

FIG. 2 illustrates a side view perspective of the invention according to the embodiment in FIG. 1.

FIG. 3 illustrates a rear view perspective of the invention according to the embodiment in FIG. 1.

FIG. 4a illustrates a rear view perspective of a basket accessory.

FIG. 4b illustrates a rear view perspective of a shelf accessory.

FIG. 5 illustrates a front perspective view of the hand cart according to another embodiment.

FIG. 6a illustrates a front perspective view of the hand cart according to another embodiment.

FIG. 6b illustrates a rear perspective view of the hand cart according to another embodiment.

FIG. 7a illustrates a rear perspective view of the hand cart according to an embodiment of the invention wherein the cart is collapsed for storage.

FIG. 7b illustrates a front perspective view of the invention according to the embodiment of FIG. 7a.

FIG. 8 illustrates a side perspective view of the hand cart according to an embodiment of the invention.

FIG. 9 illustrates a rear perspective view of an attachment according to various embodiments of the invention, wherein the attachment is adapted to attach to a hand cart.

FIG. 10 illustrates a front perspective view of the attachment according to FIG. 9.

FIG. 11a illustrates a rear perspective view of the attachment.

FIG. 11b illustrates a front perspective view of the attachment.

FIG. 12 illustrates the front perspective view of a prior art dolly suitable for use with the attachment according to certain embodiments of the invention.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

In the general embodiment of the invention, a portable collapsible hand cart is provided, the hand cart comprises a rear support panel extending from a bottom portion to a top portion, the rear support panel further comprising a plurality of hooks nested within a common plane of the support panel. The nested hooks safely provide a mechanism for attaching one or more accessories, such as a basket or shelf, as well as a mechanism for attaching one or more shopping bags to the hand cart. The nested hooks can be configured as individual nested hooks, or nested rows of many hooks.

In one embodiment, a hand cart includes a rear support panel having a plurality of hooks nested therein, a pair of wheels attached to the panel at a bottom end, and a handle attached at a top end of the panel. The handle can be etched or otherwise attached to the cart. In this embodiment, the rear support panel and nested hooks are permanently affixed to the hand cart. The hand cart can optionally be adapted for folding into a compact profile.

In another embodiment of the invention, a rear support panel comprising a plurality of hooks nested therein is adapted for attachment to a standard prior art dolly or hand cart. The attachment provides nested hooks for attaching an accessory such as a basket or shelf, as well as a mechanism for directly attaching one or more shopping bags to the support panel.

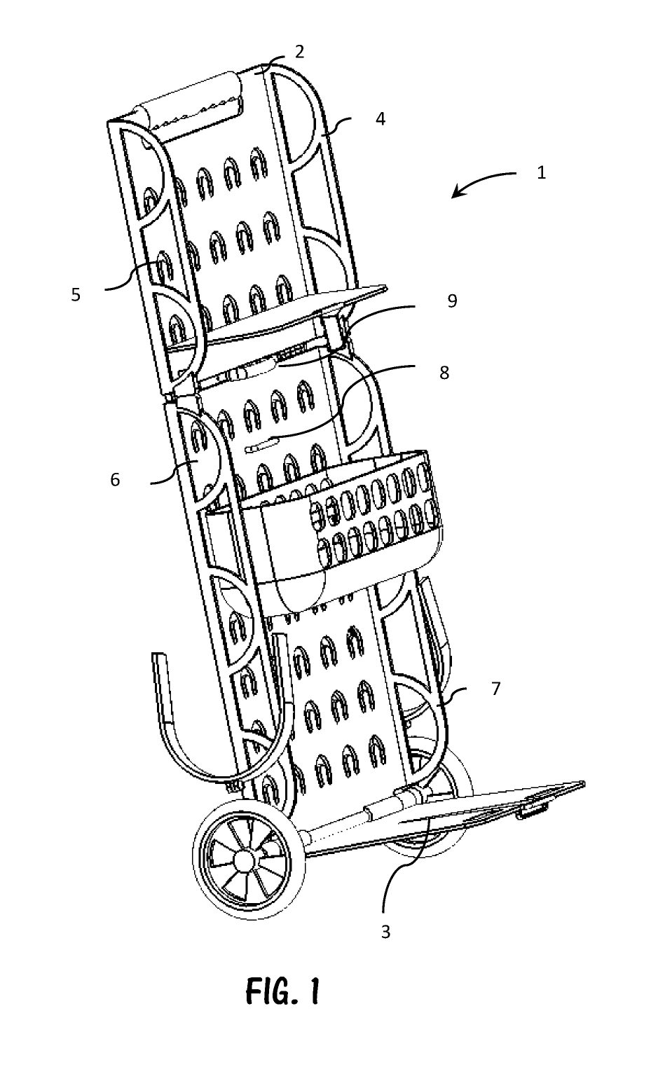

Now turning to the figures, FIG. 1 illustrates a hand cart in accordance with certain embodiments of the invention, the hand cart 1 comprises a rear support panel 2; 6 extending from a bottom end to a top end. The rear support panel is optionally configured for folding, such that the top panel 2 is adapted for folding about a hinge connecting the top panel 2 to a bottom panel 6. The top and bottom panels collectively defining the rear support panel. The rear support panel further comprises a plurality of hooks 5 nested within a common plane thereof. The nested hooks are adapted to receive and retain an accessory such as a basket, shelf, or strap. Alternatively, the nested hooks are adapted to receive and retain one or more shopping bags and contained goods. In this regard, the dolly is adapted to carry boxes, shopping bags, and other items.

The hand cart 1 can be adapted to fold at a hinged region 9, the hinged region can further comprise a handle extending from the hinge such that the folded hand cart may be adapted for carrying. Optionally, a handle 8 may be adapted to extend perpendicularly outwardly from the support panel for carrying. Additionally, one or more side rails 4; 7 can be attached to the top and bottom portions of the support panel. The side rails can be adapted to extend perpendicularly from the support panel for containing one or more shopping bags within the cart body.

The hand cart 1 can be further adapted to include a foot portion 3 for carrying one or more boxes thereon. The foot portion can be adapted for folding flush with the rear support panel for low-profile storage of the cart. During use, the foot portion can be folded to a substantially perpendicular position with respect to the rear support panel for carrying boxes and goods.

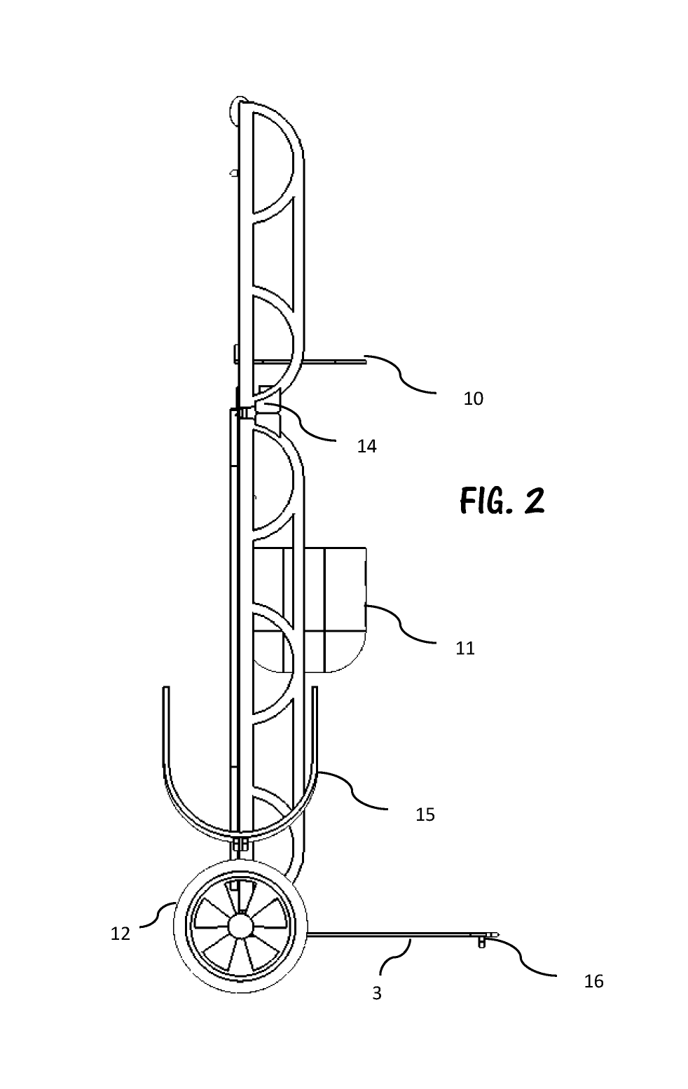

FIG. 2 illustrates a side view of the hand cart, the hand cart 1 being further adapted to receive and removeably attach one or more accessories such as a shelf 10, basket 11, or other accessory. The shelf includes a substantially planar surface and two or more attachment members for attaching the shelf to two or more planar nested hooks of the rear support panel. The shelf is adapted to attach to the panel and extend perpendicularly outwardly therefrom. The shelf may further comprise one or more side walls for retaining packages and other items on the shelf. Similarly, the basket includes a bottom portion and three or more side walls forming a receptacle for receiving and retaining goods. The basket is adapted with two or more attachment members for removeably attaching with two or more planar nested hooks of the rear support member. Other accessories can be provided and adapted to removeably attach to with the support panel of the hand cart.

The folding cart can be further adapted with locking tabs 14 extending between the top portion and bottom portions of the cart. The locking tabs can be configured to flexibly attach and mechanically release using any means known in the art. In this regard, the locking tabs can be adapted to lock the cart into an extended position for preventing unwanted folding between the top portion 2 and bottom portion 6 of the rear support member.

A wheel stand 15 can be attached to the cart at a wheel stand hinge. The wheel stand is adapted to fold down to a position surrounding a wheel for maintaining the cart in an upright standing position. A wheel stand can be provided for use at each wheel, such that each wheel stand is disposed adjacent to each wheel for use thereabout. When in use, the wheel stand can be folded upwardly to permit movement of the hand cart.

The foot portion 3 of the hand cart 1 can further include a bump rubber or folding foot-stand for further maintaining a heavy loaded cart in an upright position. The bump rubber 16 and folding foot-stand are optional features for use in certain hand carts.

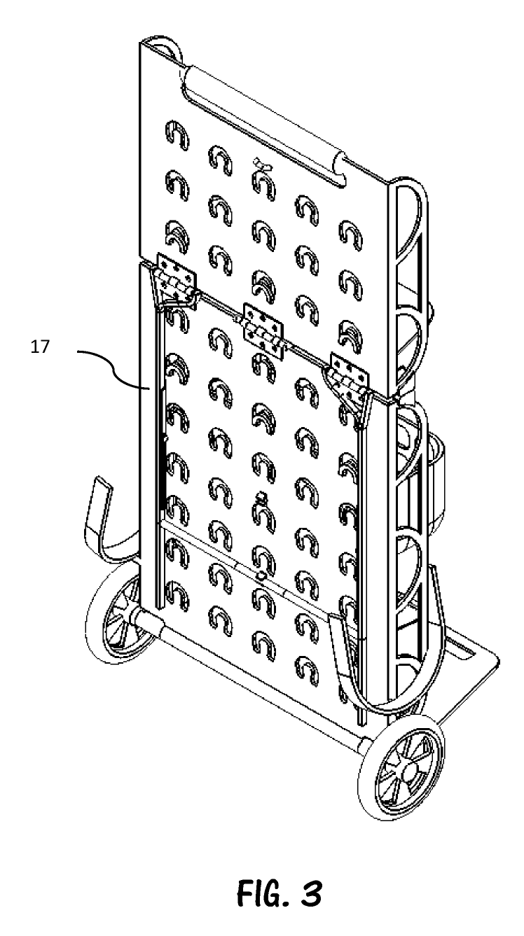

FIG. 3 further illustrates a rear view of a hand cart according to various embodiments of the invention. The hand cart further comprises one or more hinges attaching the first portion to the second portion of the rear support panel. Additionally, the hand cart can further comprise a cart stand, the cart stand comprising two legs each being attached to an axle member, the axle member can be disposed adjacent to the hinges of the rear support panel. In this regard, the cart stand can fold outwardly to effectuate a stand for preventing toppling of the hand cart.

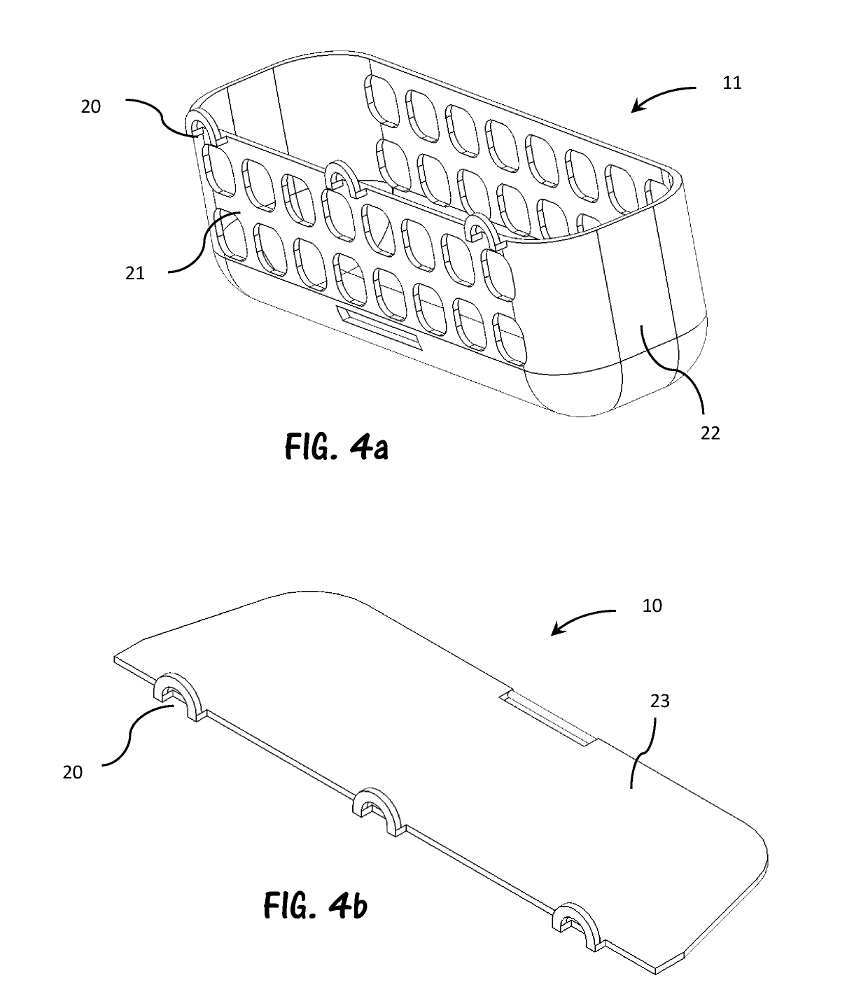

FIGS. 4a-b further illustrate various accessories for use with the hand cart. A first accessory includes a basket 11 comprises two or more attachment members 20, a first side wall 21 which can be perforated for lightweight and rigid support, and a second side wall 22. In this regard, the basket accessory is adapted to attach to two or more planar nested hooks of the rear support panel. Another accessory includes a shelf 10, the shelf comprising a substantially planar surface 23 and two or more attachment members 20 extending outwardly therefrom.

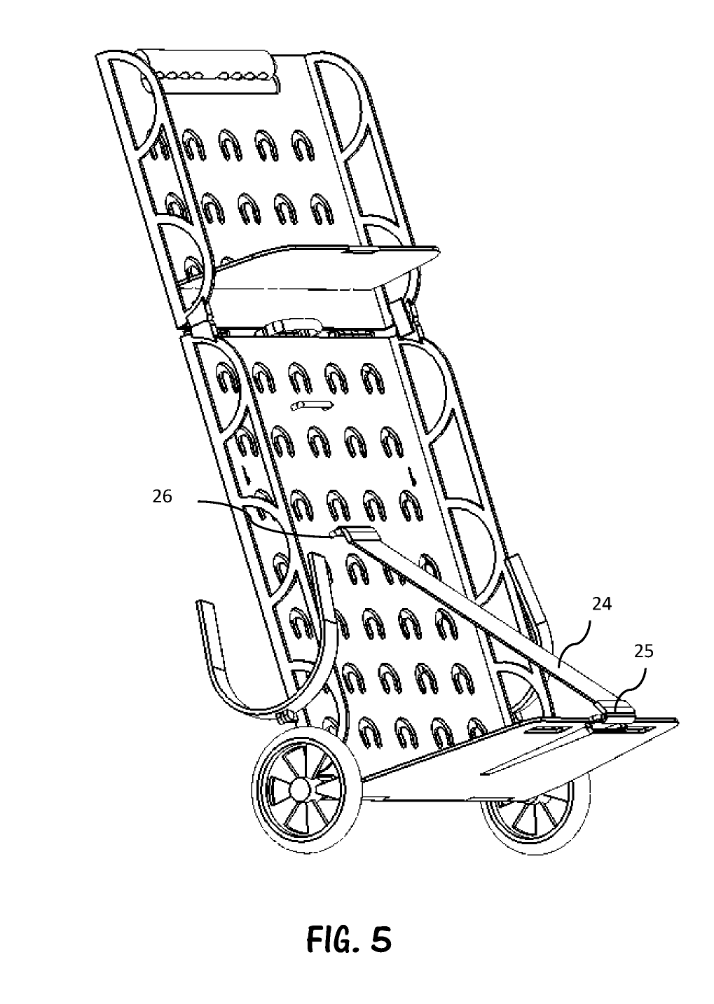

FIG. 5 illustrates a strap accessory for securing one or more boxes or other items to the hand cart. The strap accessory 24 can be adapted to attach to a handle or a planar nested hook of the hand cart at a first end 26, and further attached to a portion of the foot member at a second end 25. In this regard, the cart can be adapted to strap down and hold one or more items.

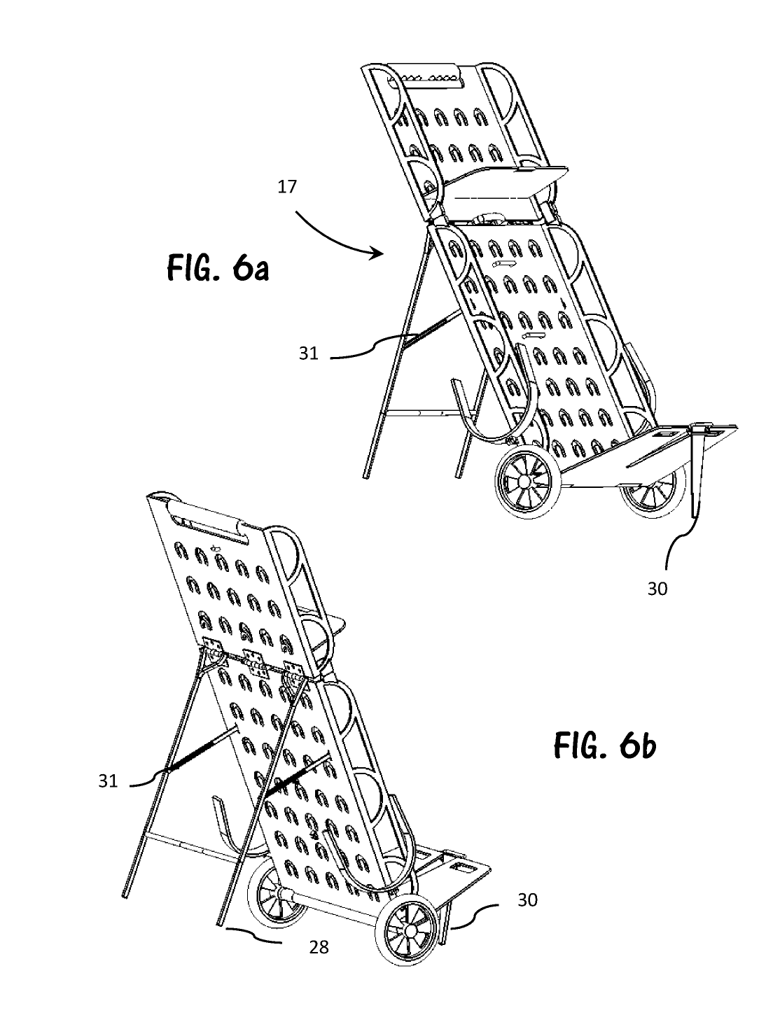

FIGS. 6a-b illustrate a foot stand and a cart stand for use in propping the cart in an upwardly position. The cart stand comprises two legs 28 extending from a rotational axle, the stand can further comprise one or more hinges 31 for folding the stand into a fixed position. The foot stand 30 includes a single leg extending from a hinge portion disposed at a base of the foot member.

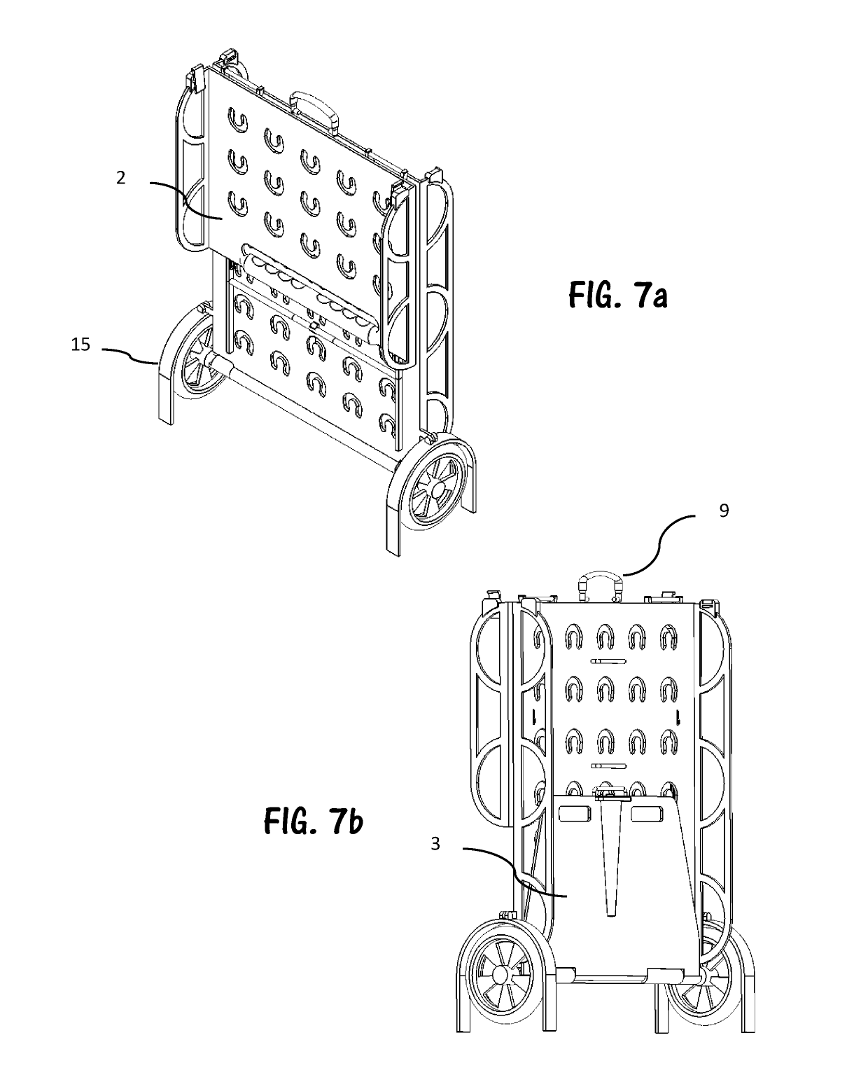

FIGS. 7a-b illustrate the folded hand cart for low-profile storage. The top portion of the rear support panel is adapted to fold about the hinge portion. The hinge portion connecting the top and bottom portions of the support member may further include a handle member 9 for providing a means to carry the collapsed hand cart.

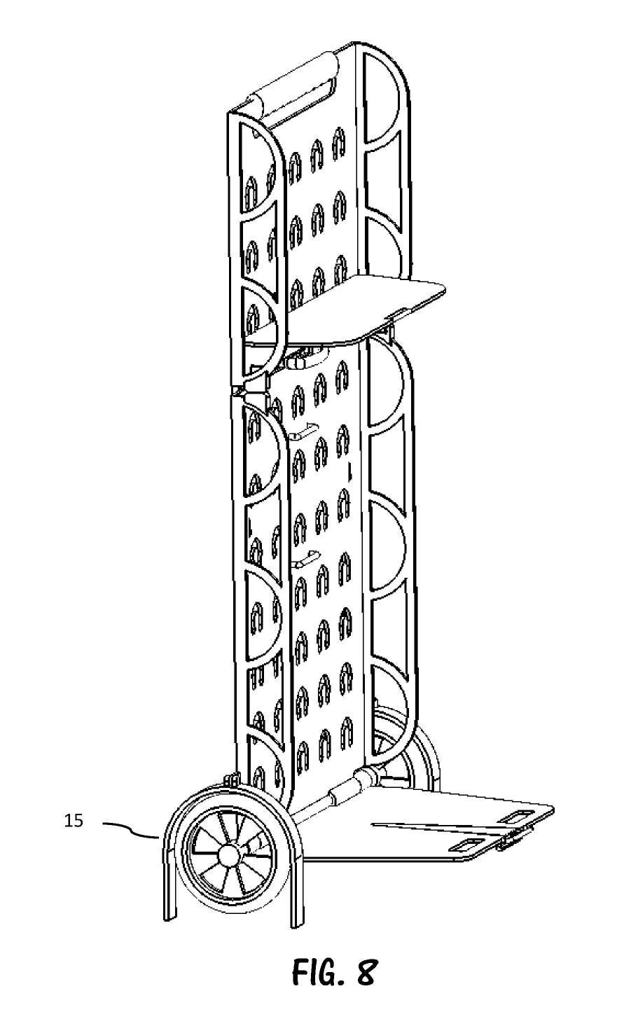

FIG. 8 further illustrates the hand cart according to various embodiments configured for substantially vertical standing using the wheel stands as described above.

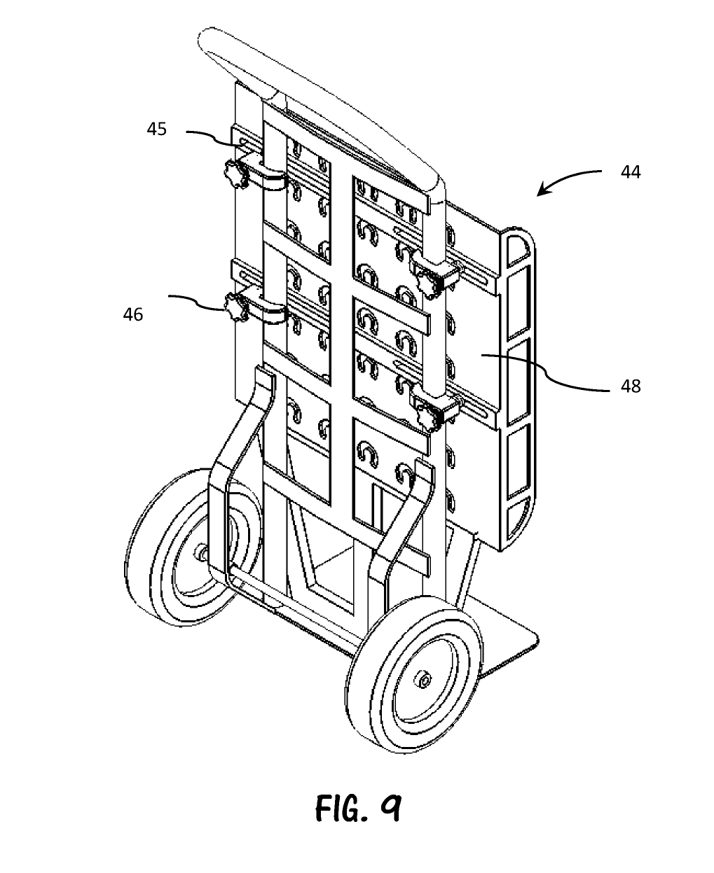

FIG. 9 illustrates another embodiment of the invention, wherein an attachment is provided for attaching to a standard prior art hand cart or hand truck, the attachment 44 comprises a rear support panel 48 having a plurality of planar nested hooks. The attachment further comprises two or more adjustable clamps 46 each being slideably engaged with a slot portion 45 of the rear support panel. In this regard, the attachment is adapted to removeably attach to any standard dolly or hand truck.

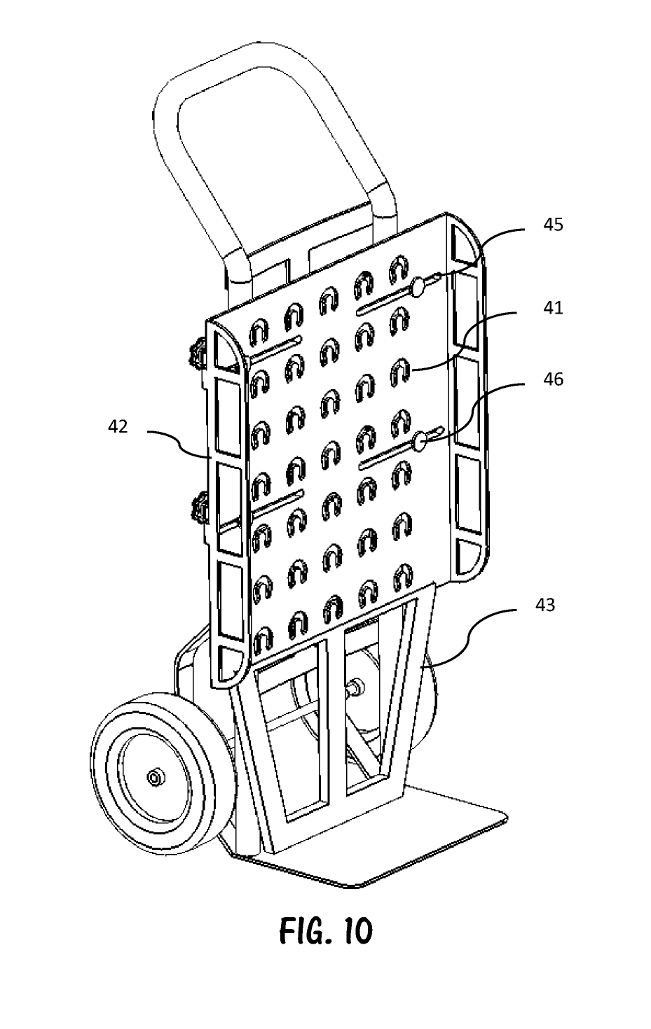

FIG. 10 further illustrates a front view of the attachment having planar nested hooks being attached to a standard dolly. The attachment comprises a rear support panel 48 having a plurality of planar nested hooks 41 and two or more slot regions 45 horizontally etched therein. At each slot portion is slideably engaged an adjustable clamp 46 for clamping to a dolly. The adjustable clamp can be a threaded knob and clamp member for tightening about one or more portions of a dolly. The attachment can further comprise side rails 42 for retaining items within a body of the attachment. Additionally, an extended frame member 43 extending downwardly from the rear support panel 48 can provide a rear support for preventing objects from falling off the dolly.

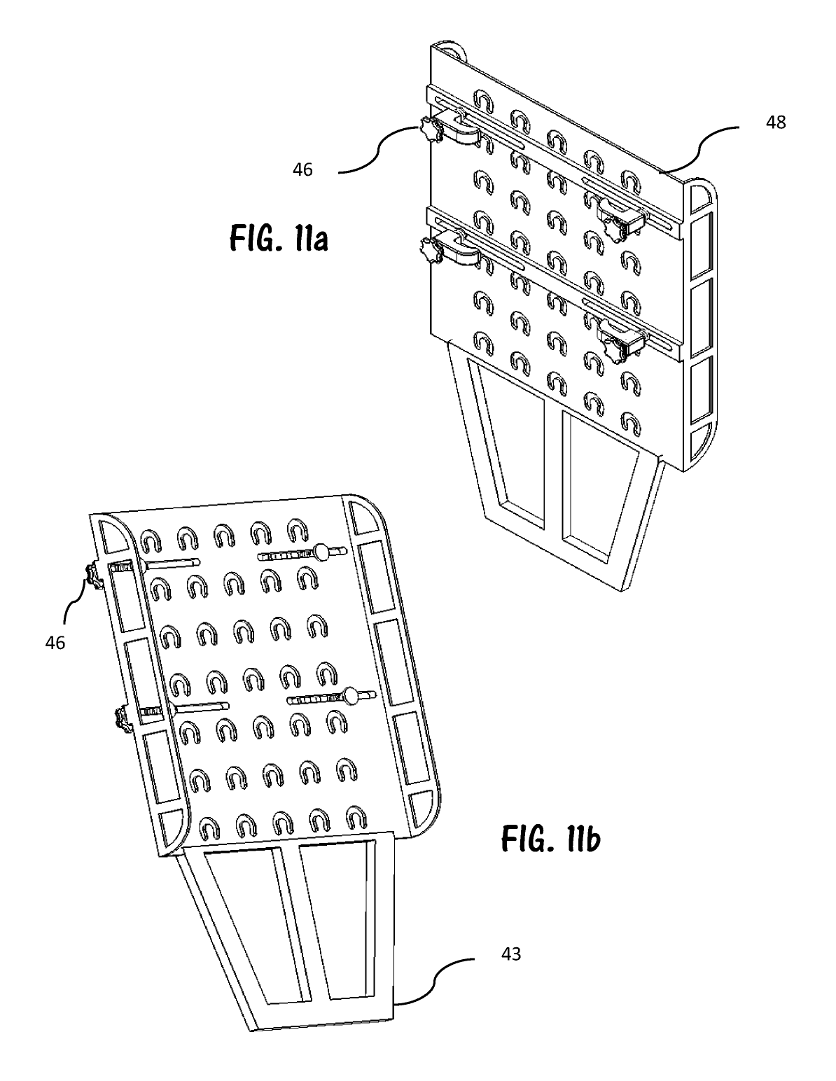

FIGS. 11a-b further illustrate the hand cart attachment as described above.

In another embodiment of the invention, a row of nested hooks are etched to provide reduced weight and comparable performance of the nested hooks described above. A nested row of hooks can be etched into the rear support panel and provides added functionality and customization of the attachment accessories. In this regard, a variety of shapes and configurations of nested hooks will be apparent to those having skill in the art upon review of these embodiments. The nested hooks can be of generally any shape, size or configuration and are deemed to be within the spirit and scope of this invention.

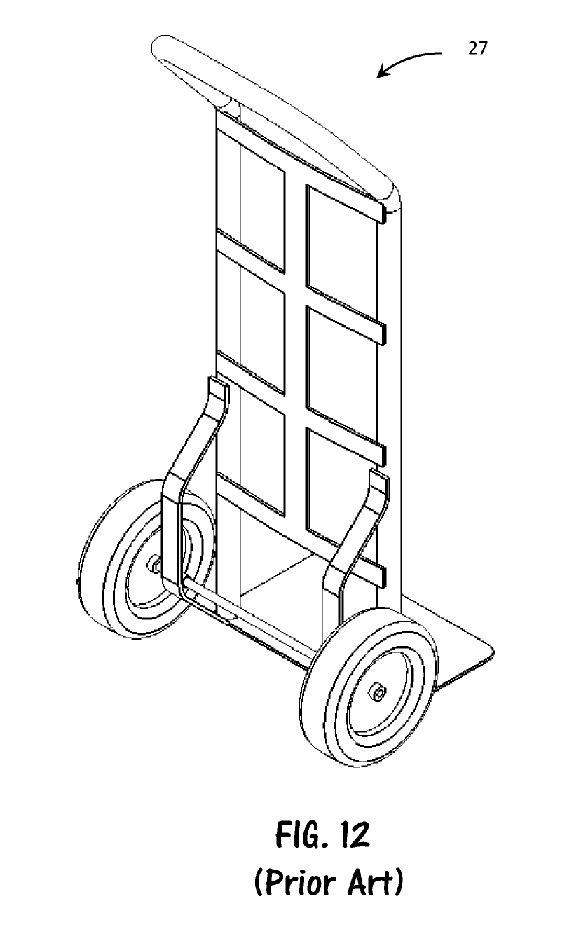

FIG. 12 illustrates a prior art hand truck, or dolly, for use with certain embodiments of the invention, particularly certain attachment embodiments as described above.

In certain embodiments, a foot frame can attach the foot member to the support panel and be adapted to fold with the foot member about a bottom end of the support panel. The foot frame can be adapted to function as a foot stand where the foot member is folded to a position perpendicular with the support panel. Additionally, when the foot member is folded upwardly, the foot frame can function as a carrying handle.

While the invention has been described with reference with a preferred embodiment, those skilled in the art will appreciate that certain substitutions, alterations and omissions may be made without departing from the spirit thereof.

I claim:

1. An article of manufacture adapted for transport of shopping bags, boxes, and other items, the article comprising:
a substantially planar support panel having a plurality of hooks nested within a plane thereof;
one or more accessories being configured for removable attachment with said support panel, said accessories selected from a strap, basket, and shelf;
wherein said one or more accessories comprises an attachment member for removeably attaching said accessories with said nested hooks of said planar support panel.

2. The article of claim 1, wherein said plurality of hooks comprises a nested row of hooks.

3. The article of claim 1, wherein said article is a hand cart.

4. The article of claim 3, wherein said hand cart further comprises two wheels and at least one wheel-stand disposed adjacent to one of said wheels, said wheel stand comprising a u-shaped structure being attached to said hand cart at a hinge such that said wheel stand is adapted to fold about said one of said wheels.

5. The article of claim 3, wherein said hand cart further comprises a foot member.

6. The article of claim 5, wherein said foot member further comprises one or a bump or foot stand.

7. The article of claim 3, further comprising a cart stand, said cart stand further comprising two legs each being connected to a rotational axel.

8. The article of claim 3, said support panel further comprising a top portion and a bottom portion, said top portion connected to said bottom portion at a hinge, wherein said cart is adapted to fold at said hinge for low-profile storage.

9. The article of claim 8, further comprising at least one locking tab for locking said cart in an extended position.

10. The article of claim 8, further comprising a handle at said hinge.

11. The article of claim 1, wherein said article is an attachment adapted to attach to a dolly or hand truck.

12. The article of claim 11, said support panel further comprising two or more slot regions and an adjustable clamp being slideably disposed at each of said slots for adjustably attaching to said dolly or hand truck.

13. The article of claim 11, further comprising an extended frame for preventing items from falling off of the article.

14. The article of claim 11, further comprising one or more rails for containing one or more items within a body of the article.

15. An article of manufacture adapted for transport of shopping bags, boxes, and other items, the article comprising:
a substantially planar support panel comprising a plurality of hooks nested within a common plane thereof;
a foot member being attached at a bottom end of said planar support panel;
two wheels;
a handle etched into said support panel at a top end thereof;
said foot member connected to a foot frame, wherein said foot frame is attached to said planar support panel and said foot frame is further attached to said foot member such that said foot frame and foot member are each adapted to fold about said support panel at said bottom end thereof;
wherein said foot frame is adapted to function as a foot stand where the foot is folded to a position perpendicular with said planar support panel.
